(19) United States
(12) Patent Application Publication
(10) Pub. No.: US 2026/0215364 A1
(43) Pub. Date: Jul. 30, 2026

(54) BRUSH CUTTER AND METHOD OF USE

(71) Applicant: Venture Products, Inc., Orrville, OH (US)

(72) Inventors: Todd DREHER, Orrville, OH (US); Corey GERBER, Wooster, OH (US)

(73) Assignee: Venture Products, Inc., Orrville, OH (US)

(21) Appl. No.: 19/449,620

(22) Filed: Jan. 15, 2026

Related U.S. Application Data
(60) Provisional application No. 63/751,036, filed on Jan. 29, 2025.

(51) Int. Cl. A01D 34/82; A01D 34/64; A01D 34/81; A01D 75/20

(52) U.S. Cl. CPC A01D 34/828; A01D 34/64; A01D 34/81; A01D 75/20

(57) ABSTRACT

An implement operable with a tractor for cutting vegetation. The implement includes a deck having a front end, a rear end opposing the front end, and a longitudinal direction extending between the front end and the rear end. The implement also includes a blade assembly that rotatably couples to and housed inside of the deck. The implement also includes a blade guard pivotally engaged with the deck between a closed position and an open position. When the blade guard is provided in the open position, a portion of the blade assembly is exposed from the deck. When the blade guard is provided in the closed position, the blade assembly is shield by the blade guard. The blade guard is also pivot from the closed position to the open position based on a predetermined pressure is applied to the blade guard.

### REFERENCE TO RELATED APPLICATIONS

This application claims the benefit of U.S. Provisional Application Ser. No. 63/751,036 filed on Jan. 29, 2025; the disclosure of which is incorporated herein by reference.

### TECHNICAL FIELD

This disclosure is directed to vegetation cutting implements, such as brush cutters, used to cut grass, shrubs, bushes, trees, and other vegetation. More particularly, this disclosure relates to a movable blade guard for a brush cutter.

### BACKGROUND ART

Rotary cutters, such as brush cutters, lawnmowers, and other rotary-blade implements, are used to cut and clear grass, brush, shrubs, bushes, and even trees from the land. These rotary cutters typically include a blade pan configured to support one or more blades attached thereto. The blade pan is attached to a gearbox, hydraulic motor, or the like, which in turn is operatively connected to a user-driven machine or vehicle such as a skid steer or tractor. For example, a cutter's gearbox may be operatively connected to a power take-off (PTO) of a tractor, or a cutter's hydraulic motor may be operatively connected to a hydraulic supply and return line extending from a hydraulic pump a user-operated machine.

Such rotary cutters typically include a deck substantially surrounding the blades to prevent inadvertent contact with the spinning blades and to shield clippings or debris from being thrown from the rotary cutter causing damage or injury to surrounding bystanders. However, these decks limit what types and sizes of vegetation that the cutter may be used to cut. More particularly, because the deck substantially surrounds the spinning blades, the only vegetation that can encounter the blades is that which can fit underneath the margins of the deck, such as grass or vegetation that is below that bottom edge of the deck. Thus, the cutter may not be suitable for trimming shrubs, bushes, trees, and other types of tall vegetation that is too large to easily fit underneath an edge of the deck.

While some cutters include a movable guard to expose part of the blade path to cut large shrubs, bushes, trees, and the like, these cutters require complex linkages and other actuating mechanisms to move the guard out of the way of the vegetation. Moreover, many movable guards require that an operator move the cutter deck in a certain fashion to actuate the movable guard in order for the cutter to trim and cut bushes, brush, trees, and other similar freestanding vegetation. These types of processes are time consuming and disruptive to the normal travel of the cutter.

### SUMMARY OF THE INVENTION

Thus, there remains a need for a rotary cutter or brush cutter that includes a deck that suitably shields the cutting path during use, but allows the cutter to be used to trim bushes, shrubs, trees, and other tall vegetation that otherwise could not fit below the outer edges of the deck. Moreover, there remains a need for a rotary cutter or brush cutter that may to trim bushes, shrubs, trees, and other tall vegetation during a typical cutting operation (i.e., forward movement of the cutter) without requiring an operator to perform further actions to actuate the movable blade guard when trimming bushes, shrubs, trees, and other tall vegetation.

The presently disclosed implement includes a movable blade guard that addresses such need. Particularly, the presently disclosed movable blade guard is pivotable between a closed position when trimming grass or low height vegetation and an open position when trimming or cutting bushes, shrubs, trees, and other tall or freestanding vegetation that otherwise could not fit below the outer edges of the deck. The implement also includes a pivot assembly that pivotally engages the blade guard to the deck in order to move the blade guard when an operator intends to trim tall vegetation that otherwise could not fit below the outer edges of the deck. The pivot assembly includes a biaser that biases the blade guard to the closed position to prevent inadvertent contact with the spinning blades and to shield clippings or debris from being thrown from the rotary cutter causing damage or injury to surrounding bystanders. When the operator intends to trim bushes, shrubs, trees, and other tall vegetation, the biasing force applied by the biaser may be overcome based on the opposing force applied by the vegetation against the blade guard as the implement proceeds towards the vegetation. As such, the implement disclosed herein addresses some of the inadequacies of previously known rotary cutters and other similar implements having movable blade guards.

In one aspect, an exemplary embodiment of the present disclosure may provide an implement operable with a tractor. The implement includes a deck having a front end, a rear end opposing the front end, and a longitudinal direction extending between the front end and the rear end. The implement also includes a blade assembly rotatably coupled to and housed inside of the deck. The implement also includes a blade guard pivotally engaged with the deck between a closed position and an open position; wherein a portion of the blade assembly is exposed from the deck when the blade guard is provided in the open position.

This exemplary embodiment or another exemplary embodiment may further include that when the blade guard is in the open position to expose the portion of the blade assembly, a leading edge of the blade guard is substantially parallel to the longitudinal direction of the deck. This exemplary embodiment or another exemplary embodiment may further include that a predetermined pressure is applied to the blade guard to pivot the blade guard from the closed position to the open position. This exemplary embodiment or another exemplary embodiment may further include a pivot axis extending between top and bottom ends of the deck and being non-parallel to the longitudinal direction of the implement; wherein the blade guard rotates about the pivot axis between the closed position and the open position. This exemplary embodiment or another exemplary embodiment may further include that the blade guard moves between the closed position and the open position along a hypothetical plane that is parallel to a top end of the implement. This exemplary embodiment or another exemplary embodiment may further include that the front end of the deck and a leading edge of the blade guard collectively define a leading end of the implement in the closed position. This exemplary embodiment or another exemplary embodiment may further include that a predetermined pressure is applied to the blade guard, by vegetation, to pivot the blade guard from the closed position to the open position. This exemplary embodiment or another exemplary embodiment may further include a rail operably engaged with the deck and configured to guide the blade guard between the closed position and the open position. This exemplary embodiment or another exemplary embodiment may further include that a portion of the blade guard is housed inside of and slidably engages with the rail. This exemplary embodiment or another exemplary embodiment may further include a pivot pin pivotally engaging the blade guard with a top end of the deck. This exemplary embodiment or another exemplary embodiment may further include a biaser operably engaging with the blade guard and the deck and positioned inside of the pivot pin; wherein the biaser biases the blade guard to the closed position. This exemplary embodiment or another exemplary embodiment may further include a strut operably engaging with the blade guard and the deck; wherein the strut applies linear force against the blade guard as the blade guard pivots from the closed position to the open position. This exemplary embodiment or another exemplary embodiment may further include that the deck comprises: a compartment defined by a top end of the deck and a set of supports of the deck extending from the front end of the deck; wherein a portion of a cutting blade of the blade assembly enters the compartment to cut vegetation inside side the compartment. This exemplary embodiment or another exemplary embodiment may further include that the blade guard covers the compartment in the closed position at one of the top end of the deck and at the front end of the deck. This exemplary embodiment or another exemplary embodiment may further include that the blade guard covers the compartment in the closed position at the top end of the deck and at the front end of the deck.

In another aspect, an exemplary embodiment of the present disclosure may provide an implement operable with a tractor. The implement includes a deck having a front end, a rear end opposing the front end, and a longitudinal direction extending between the front end and the rear end. The implement also includes a blade assembly rotatably coupled to and housed inside of the deck. The implement also includes a blade guard pivotally engaged with the deck between a closed position and an open position; wherein a portion of the blade assembly is exposed from the deck when the blade guard is provided in the open position. The implement also includes a rail operably engaged with the deck and configured to guide the blade guard between the closed position and the open position.

In yet another aspect, an exemplary embodiment of the present disclosure may provide a method of cutting upright vegetation. The method includes steps of contacting the vegetation with a blade guard of an implement; pivoting the blade guard, by the upright vegetation, from a closed position to an open position as the implement moves towards the upright vegetation in a longitudinal direction; exposing a portion of a blade assembly of the implement from a deck of the implement; and cutting the upright vegetation with the blade assembly.

This exemplary embodiment or another exemplary embodiment may further include that when the blade guard is in the open position to expose the portion of the blade assembly, a leading edge of the blade guard is substantially parallel to the longitudinal direction of the deck. This exemplary embodiment or another exemplary embodiment may further include that the pivoting the blade guard further comprises: pivoting the blade guard about a pivot axis extending between top and bottom ends of the deck and being generally orthogonal to the longitudinal direction of implement. This exemplary embodiment or another exemplary embodiment may further include that the pivoting the blade guard further comprises: moving the blade guard along a hypothetical plane that is parallel to a top end of the implement. This exemplary embodiment or another exemplary embodiment may further include a front end of the deck and a leading edge of the blade guard collectively define a leading end of the implement in the closed position. This exemplary embodiment or another exemplary embodiment may further include: biasing the blade guard, by a biaser, to the closed position.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a side elevation view of an implement in accordance with one aspect of the present disclosure, wherein the implement is equipped to a tractor and includes a movable blade guard.

FIG. 2 (FIG. 2) is a top, front, first side isometric perspective view of the implement.

FIG. 2A (FIG. 2A) is an enlargement of the highlighted region denoted in FIG. 2, wherein the movable blade guard of the implement is shown.

FIG. 3 (FIG. 3) is a partial top plan view of the implement.

FIG. 3A (FIG. 3A) is an enlargement of the highlighted region denoted in FIG. 3 showing the movable blade guard and a pivot assembly while a rail and a rail support are partially cut away.

FIG. 4 (FIG. 4) is a partial bottom plan view of the implement.

FIG. 4A (FIG. 4A) is an enlargement of the highlighted region denoted in FIG. 4 showing the movable blade guard.

FIG. 5 (FIG. 5) is a sectional view of the implement taken in the direction of line 5-5 shown in FIG. 3.

FIG. 6 (FIG. 6) is an operational view of the implement equipped to the tractor, wherein the tractor and the implement move towards an freestanding vegetation in a longitudinal direction.

FIG. 7A (FIG. 7A) is another operational view continuing from FIG. 6, wherein the freestanding vegetation contacts the movable blade guard at a closed position as the tractor and the implement move into the freestanding vegetation.

FIG. 7B (FIG. 7B) is another operational view continuing from FIG. 7A, wherein the movable blade guard pivots from a closed position towards an open position as the freestanding vegetation remains in contact with the blade guard and the tractor and the implement continue to move into the freestanding vegetation.

FIG. 7C (FIG. 7C) is another operational view continuing from FIG. 7C, wherein the movable blade guard pivots at the open position while the freestanding vegetation remains in contact with the blade guard and the tractor and the implement continue to move into the freestanding vegetation.

FIG. 7D (FIG. 7D) is another operational view similar to FIG. 7D, wherein a blade assembly of the implement is cutting into the freestanding vegetation when the blade guard is at the open position.

FIG. 7E (FIG. 7E) is another operational view continuing from FIG. 7D, wherein the movable blade guard is biased to the closed position by the pivot assembly once the freestanding vegetation is cut down.

FIG. 8 (FIG. 8) is a diagrammatic flowchart of a method of cutting vegetation

Similar numbers refer to similar parts throughout the drawings.

### DETAILED DESCRIPTION

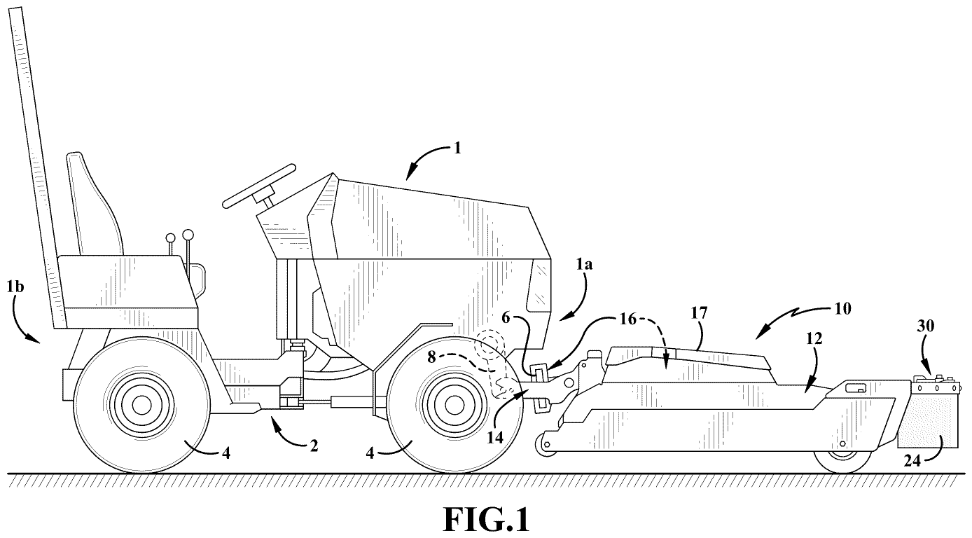

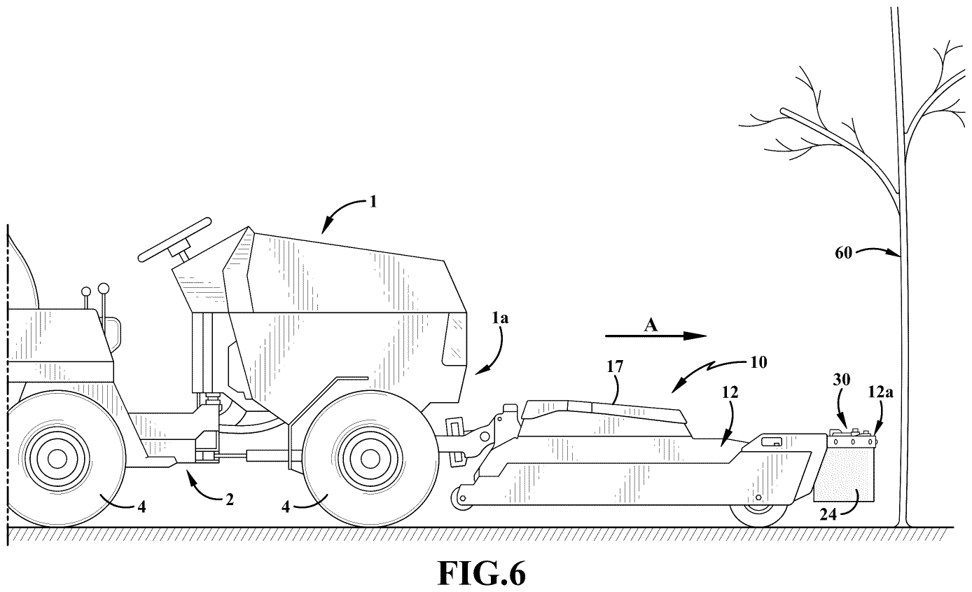

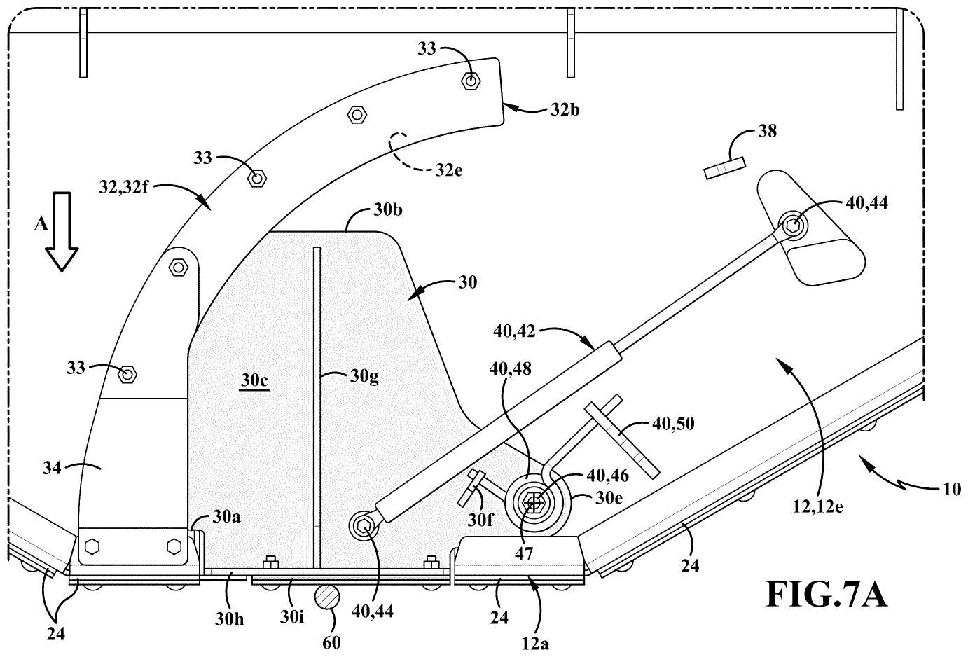

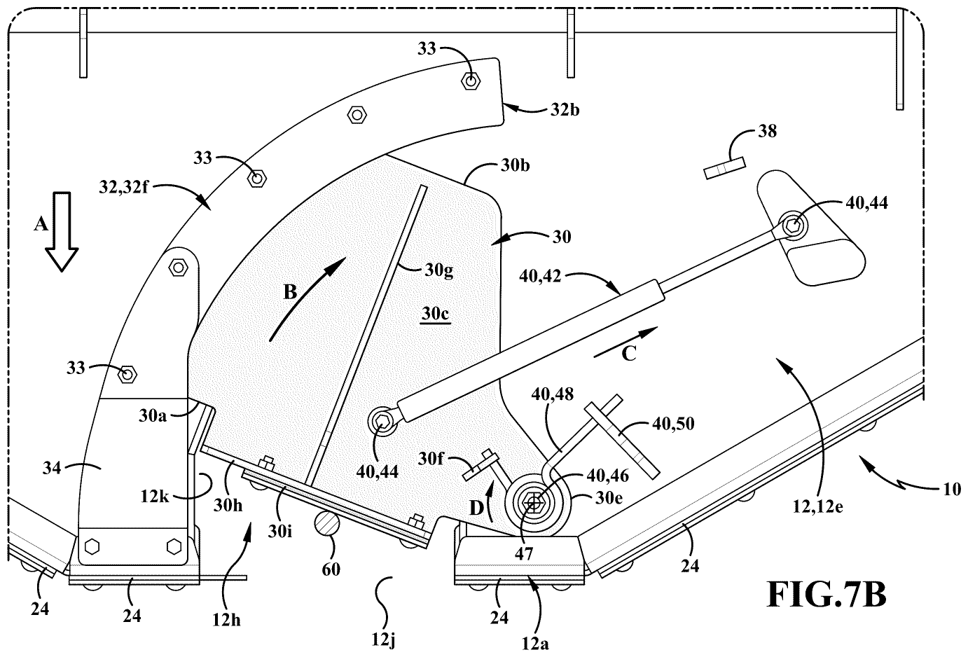

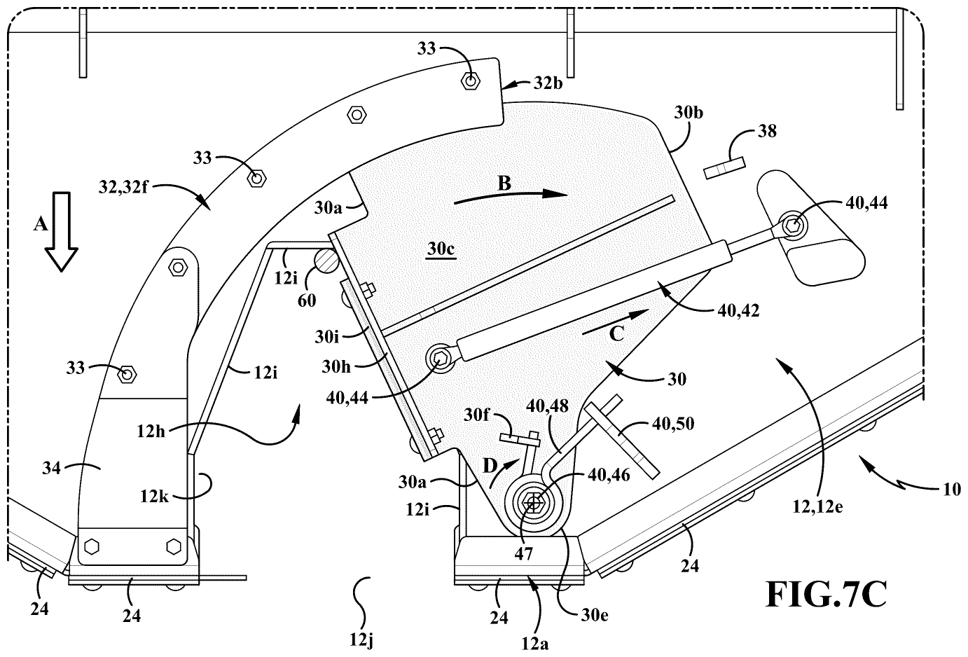

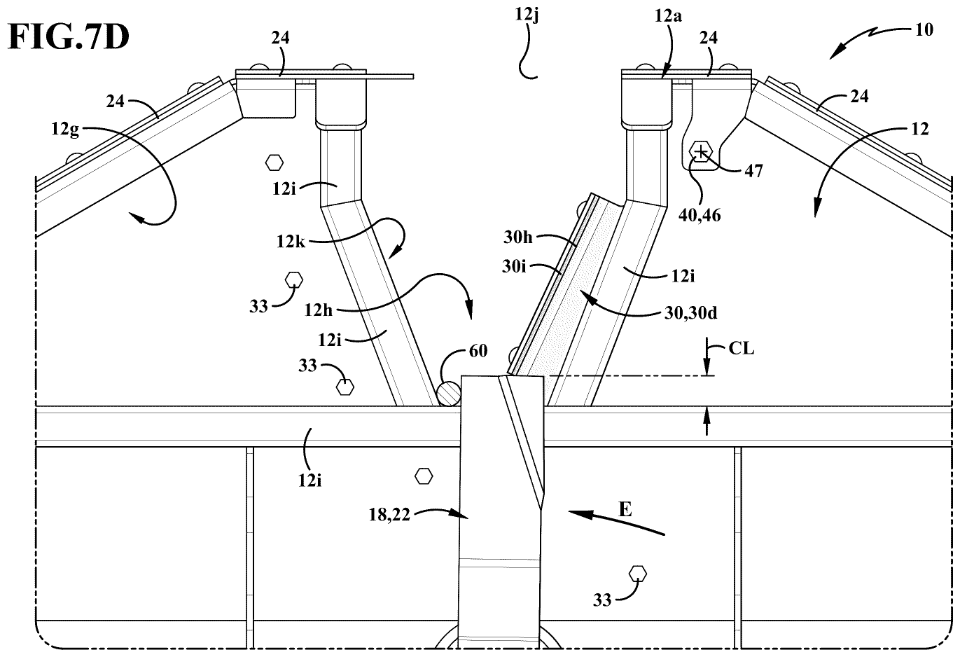

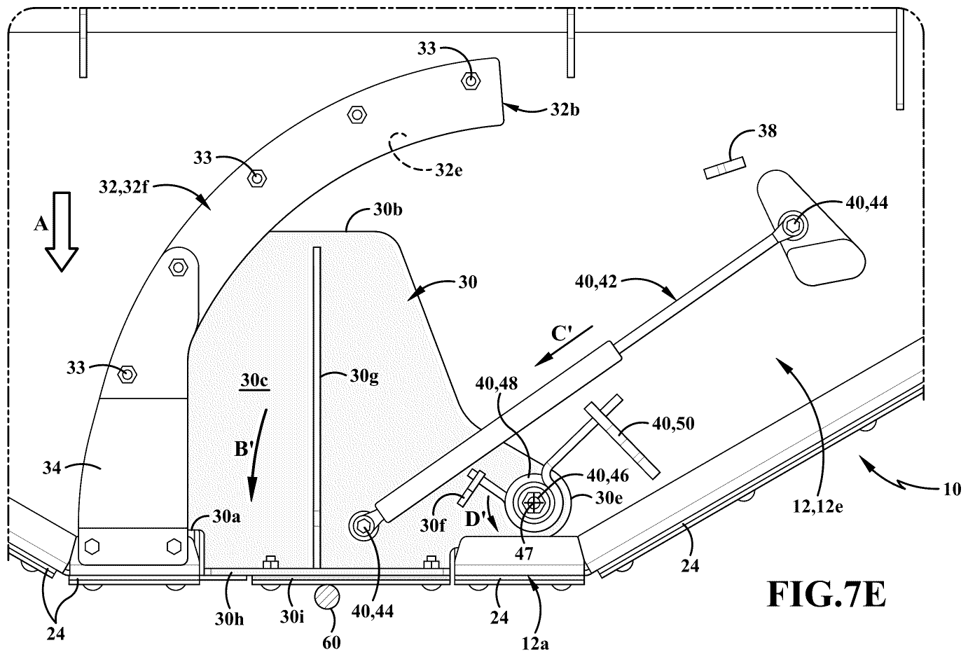

A drivable outdoor power equipment unit in accordance with the present disclosure is illustrated in FIG. 1 and is shown generally at 1; the drivable outdoor power equipment device 1 may also be referred to as a tractor or vehicle herein. Vehicle 1 has a front end 1A, a rear end 1B longitudinally opposite to the front end 1A, and a longitudinal direction defined therebetween. During operation, vehicle 1 will typically travel in a forward direction indicated by the arrow “A” (FIGS. 6-7C). When vehicle 1 moves in the forward direction “A”, the front end 1A comprises the leading end of vehicle 1. In some instances, vehicle 1 may need to reverse, in which case the direction of travel will be opposite to the direction indicated by arrow “A”, and then rear end 1B will comprise the leading end of the vehicle 1.

Vehicle 1 includes an articulating frame 2 upon which grounding engaging wheels 4 are mounted so that vehicle 1 may be driven across a ground surface. Vehicle 1 may include a power takeoff (PTO) system 6 that may connect with a compatible implement described herein or that is commercially available. During operation, the PTO system 6 may deliver and transfer mechanical or rotational energy to an implement connected to the PTO system 6. Such transferring of mechanical energy from the PTO system 6 to the connected implement may be controlled by an on-board control system provided on the vehicle 1 and accessible by an operator of vehicle 1. Vehicle 1 may also include a set of attachment arms 8 that is controlled by the operator 1 of vehicle 1 and is configured to equip an implement to vehicle 1 for brush cutting or vegetation cutting operations; such implement used for brush cutting or vegetation cutting operations is discussed in greater detail below.

It will be understood that any suitable vehicle, tractor, or drivable outdoor power equipment device may be used with an implement discussed herein. One exemplary vehicle 1 for use with an implement discussed herein is a Ventrac compact tractor commercially available for sale and known in the industry as a Ventrac 4520 tractor.

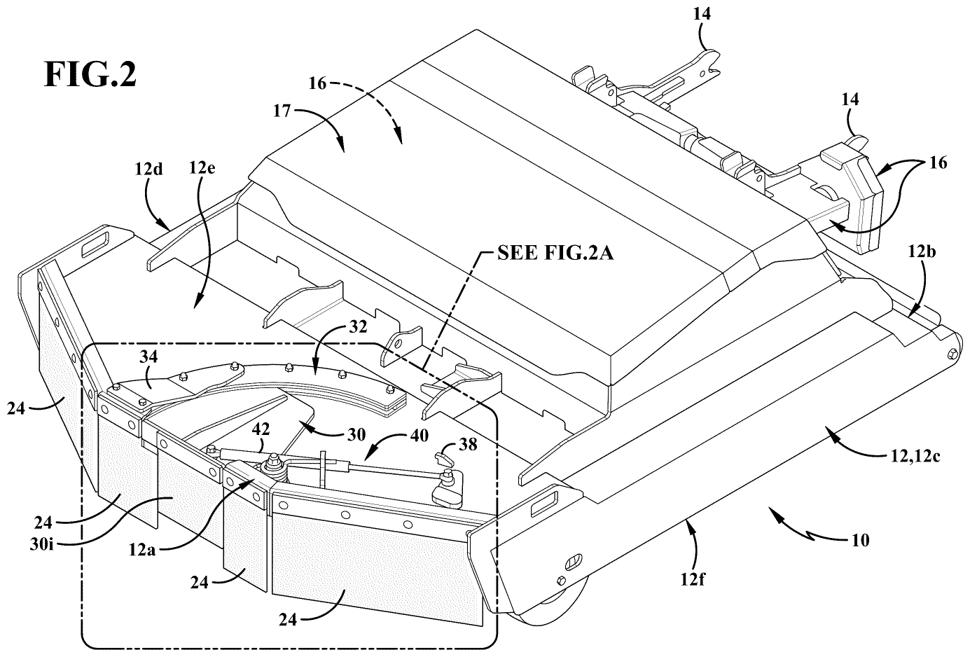

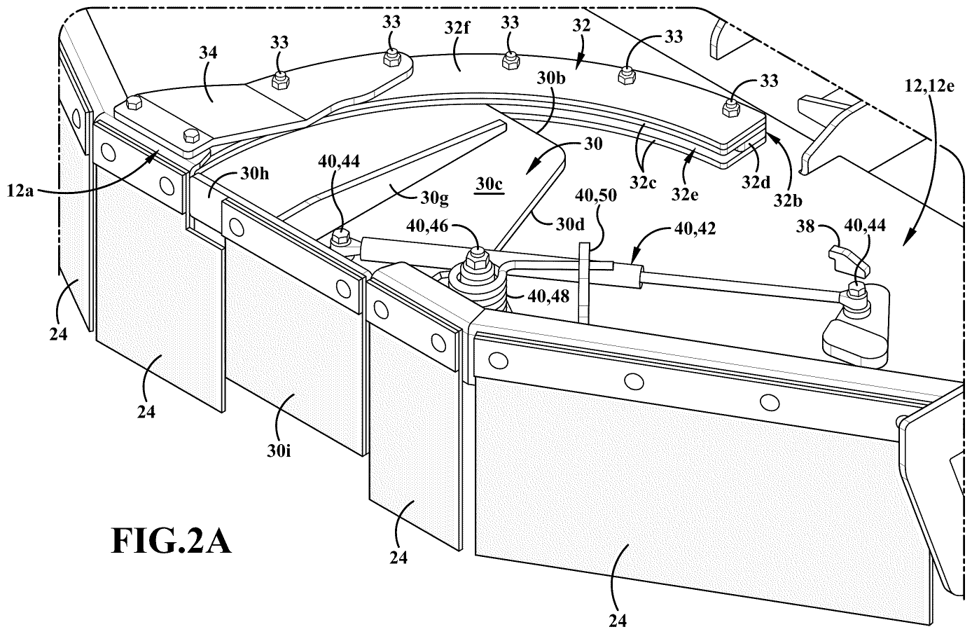

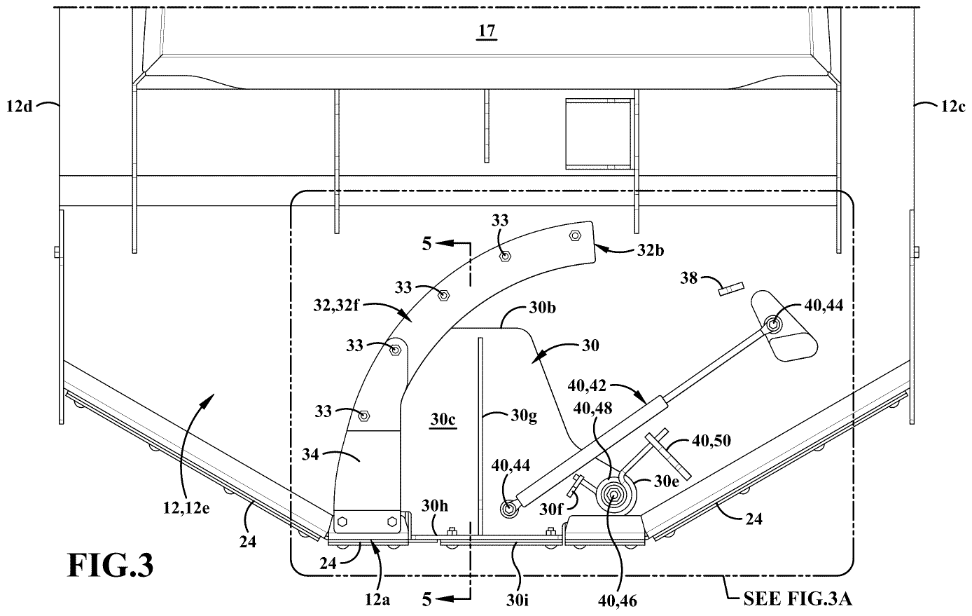

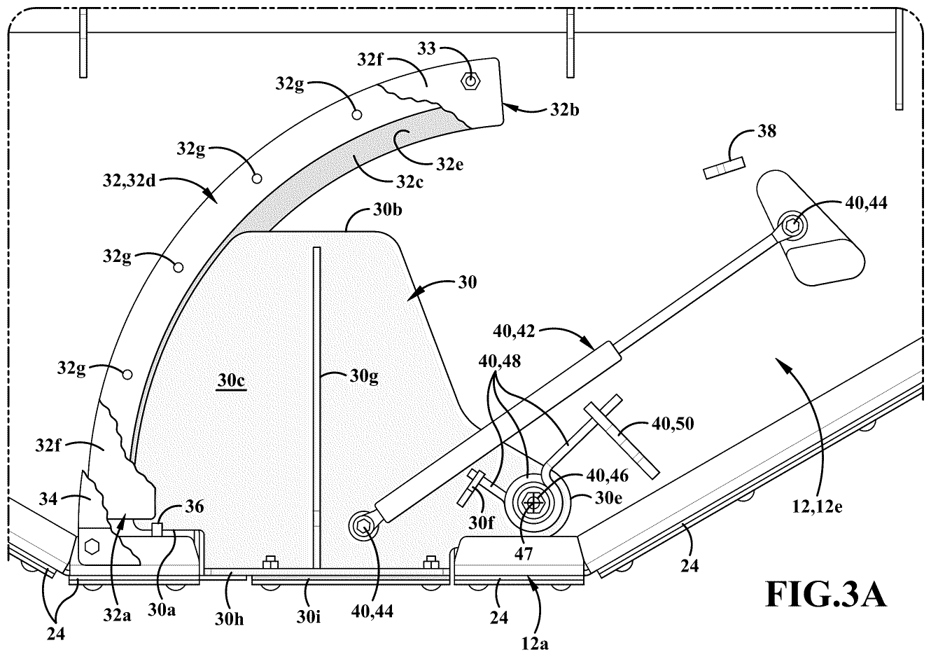

FIGS. 2-5 illustrate an implement or brush cutter 10 operably engaged with vehicle 1 at the set of attachment arms 8. In operation, implement 10 is configured to cut vegetation or brush at low or ground level that is lower than the bottom end of implement 10 or may be forced underneath the implement 10 (such as grass or low vegetation) and to cut vegetation or brush that extends above the bottom end of implement 10 and/or may not be forced underneath the implement 10 (such as bushes, shrubs, trees, or similar freestanding vegetation) simultaneously. As discussed in greater detail below, implement 10 includes a brush guard that is configured to be pivoted between a closed position (see FIGS. 3, 4, 7A, and 7E) and an open position (see FIGS. 7C-7D) based on an interaction with vegetation that forces the brush guard to the open position. In the open position, vegetation enters into the implement where a blade assembly of the implement 10 cuts into the vegetation to remove said vegetation from the ground surface. Such components of implement 10 are now discussed in greater detail below.

Implement 10 includes a main body or deck 12 that houses and supports a majority of the components and parts of implement 10. As best seen in FIG. 2, deck 12 includes a first or front end 12a, a second or rear end 12b longitudinally opposite to the front end 12a, and a longitudinal axis defined between the front end 12a and the second end 12b. It should be noted that such longitudinal axis of deck 12 is substantially parallel with the longitudinal direction “A” of vehicle 1 when implement 10 is operably engaged with vehicle 1. It should also be noted that front end 12a of deck 12 is the leading end when vehicle 1 and implement 10 are moving forward in the longitudinal direction “A” of vehicle 1. Deck 12 also includes a first side 12c that is positioned between the front end 12a and rear end 12b, a second side 12d that is positioned between the front end 12a and rear end 12b and transversely opposite to first side 12c, and a transverse axis defined between first and second sides 12c, 12d. Deck 12 also includes a top end 12e that is positioned above front and rear ends 12a, 12b and first and second sides 12c, 12d, a bottom end 12f that is positioned below front and rear ends 12a, 12b and first and second sides 12c, 12d and is vertically opposite to top end 12e, and a vertical axis defined between top and bottom ends 12e, 12f.

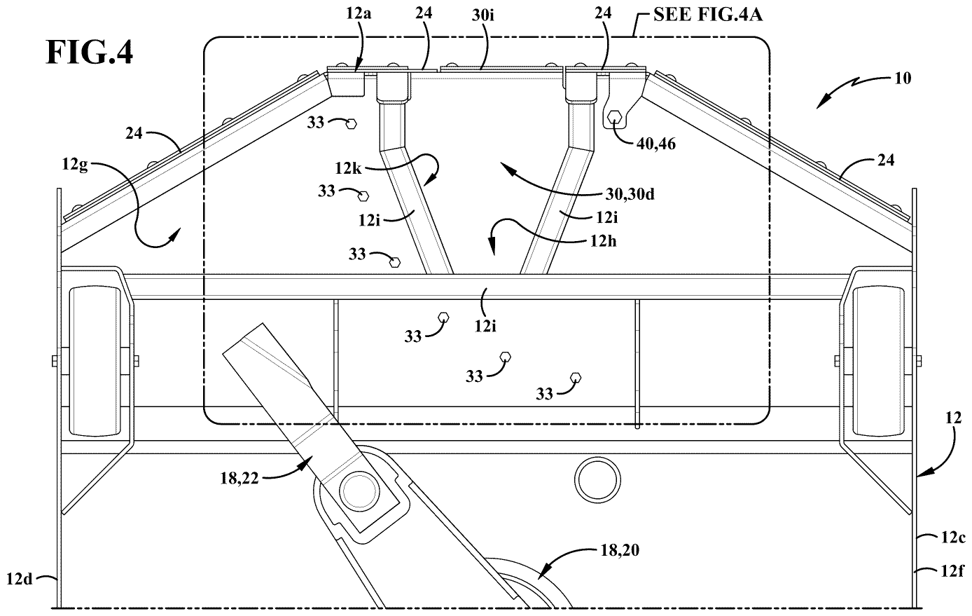

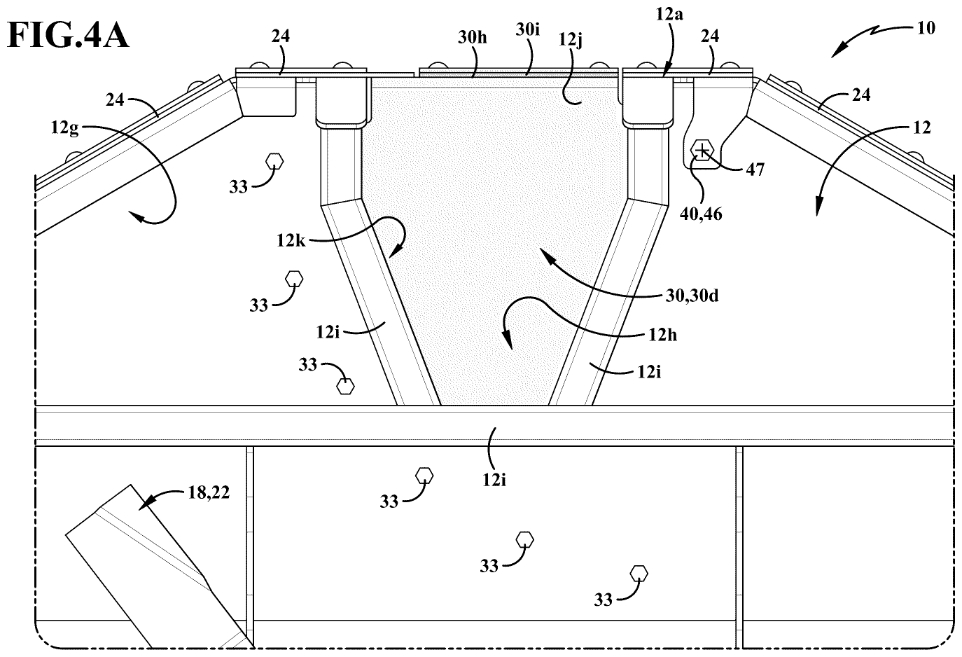

Still referring to deck 12, deck 12 also defines a chamber 12g (see FIGS. 4 and 4A) that is collectively defined by the front and rear ends 12 a, 12 b, first and second sides 12c, 12d, and top and bottom ends 12e, 12f. Deck 12 also defines a front compartment 12h that is collectively defined by a set of supports 12i that operably engage with the front end 12a, first and second sides 12c, 12d, and the top end 12e of deck 12 (see FIGS. 4-4A). In the present disclosure, front compartment 12h provides communication between the chamber 12g of deck 12 and the exterior environment that surrounds the deck 12 at both a front slot 12j defined at the front end 12a of deck 12 between two adjacent shrouds 24 and a top opening 12k defined in the top end 12e of deck 12 (see FIGS. 7C-7D); such use and purpose of front compartment 12h is discussed in greater detail below. The set of supports 12i also provides assistance in directing or guiding at least one vegetation into the front compartment 12h of deck 12 so that a blade assembly of implement 10 may cut into the vegetation to remove said vegetation from the ground surface.

Implement 10 also includes a pair of engagement arms 14 that are fixedly engaged with the deck 12 at the rear end 12b. As best seen in FIG. 1, the pair of engagement arms 14 enables implement 10 to be operably engaged with the attachment arms 8 of vehicle 1 so that implement 10 may be equipped to vehicle 1 for removing and cutting brush or vegetation. It should be noted that such pair of engagement arms 14 may be similar to pairs of engagement arms 14 currently used on similar implements, including products or implements developed by Venture Products, Inc.

Implement 10 also includes a drive assembly or power takeoff (PTO) assembly 16 that is configured to rotate or spin a blade assembly 18 of implement 10 inside of chamber 12g of deck 12 (see FIG. 1). In the present disclosure, drive assembly 16 is configured to be coupled or engaged with PTO 6 of vehicle 1 in order to receive mechanical energy to rotate or spin blade assembly 18 for cutting brush or vegetation. As such, drive assembly 16 includes necessary drive components and/or PTO components necessary for rotating and/or spinning blade assembly to cut brush or vegetation. It should also be understood that shrouds, covers, and other protective components may be fitted to implement 10 to protect or shield drive or PTO components of drive assembly 16 to prevent unwanted or inadvertent damage to such components when implement 10 is being transported or is being used to cut and remove brush and vegetation. In one example, and as best seen in FIG. 2, a top cover 17 protects drive or PTO components of drive assembly 16 to prevent unwanted or inadvertent damage to such components when implement 10 is being transported or is being used to cut and remove brush and vegetation.

Referring now to blade assembly 18 of implement 10, blade assembly 18 includes at least a blade support or blade pan 20 that is coupled to a blade spindle of the drive assembly 16 of implement 10 (see FIG. 4). Additionally, blade assembly 18 also includes at least one cutting blade 22 that is removably engaged with the blade pan 20 for cutting brush or vegetation. In the present disclosure, blade assembly 18 includes two cutting blades 22 that are positioned on opposite ends of blade pan 20. In other exemplary embodiments, blade assembly 18 may include any suitable number of cutting blades dictated by the implementation of implement 10. As discussed in greater detail below, blade assembly 18 may cut one or more types of vegetation based on the position of a blade guard of implement 10 during operation of implement 10.

Implement 10 also includes a series of front shrouds or shields 24. As best seen in FIG. 2, the series of front shrouds 24 operably engage with the front end 12a of deck 12 that covers the chamber 12g from the front end 12a. Such use of the series of front shrouds 24 shields cut vegetation from being thrown outside of the chamber 12g of the deck 12 and maintains the cut vegetation inside of the chamber 12g for safety of the operator or individuals that are near or is close proximity to the implement 10 during operation.

Implement 10 also includes a blade guard 30 that is pivotally engaged with the deck 12 between a closed position (FIGS. 3, 4, 7A, and 7E) and an open position (see FIGS. 7C-7D) based on the type of vegetation being cut by the blade assembly 18. As best seen in FIG. 3A, blade guard 30 includes a first or forward end 30a that is positioned proximate to the front end 12a of deck 12, a second or trailing end 30b opposite to the forward end 30a and positioned away from front end 12a, and a lengthwise axis defined between the forward end 30a and the trailing end 30b. Blade guard 30 also includes a top surface 30c that extends between the forward end 30a and the trailing end 30b and is in communication with the exterior environment surrounding implement 10. Blade guard 30 also includes a bottom surface 30d that extends between the forward end 30a and the trailing end 30b and is in communication with the chamber 12g of deck 12 while facing the ground surface.

Referring to FIG. 3A, blade guard 30 also includes a protrusion 30e that extends outwardly at a location between the forward end 30a and the trailing end 30b; such protrusion 30e is positioned proximate to the forward end 30a of blade guard 30. As discussed in greater detail below, protrusion 30e is configured to receive and engage with a pivot pin of a pivot assembly of implement 10 so that the blade guard 30 may pivot between the closed position and the open position when interacting with one or more types of vegetation.

Still referring to FIG. 3A, blade guard 30 also includes a hook or retainer 30f that extends outwardly from top surface 30c and positioned proximate to protrusion 30e. In the present disclosure, hook 30f is configured to engage with a first end of a biaser or spring of a pivot assembly of implement 10 to maintain tension on the spring for operation purposes, which is discussed in greater detail below. Blade guard 30 also includes a spine or axial support member 30g that extends longitudinally between the forward end 30a and the trailing end 30b. In operation, spine 30g may provide axial support along the longitudinal axis of blade guard 30 between the forward end 30a and the trailing end 30b when the blade guard 30 contacts and interacts with one or more types of vegetation. As such, the spine 30g may provide additional rigidity and strength to the blade guard 30 along the longitudinal axis of blade guard 30 to prevent the blade guard 30 from bending or deforming after contacting numerous interactions with various types of vegetation.

Still referring to FIG. 3A, blade guard 30 also includes a ram or engagement end 30h that extends outwardly from forward end 30a. In the present disclosure, ram 30h is configured to initially contact the vegetation as the implement 10 approaches and moves towards the vegetation for cutting operations. In the present disclosure, ram 30h is a bent portion of blade guard 30 that extends outwardly from the forward end 30a in which ram 30h is the leading end of blade guard 30 that initially contacts the vegetation during cutting operations.

Still referring to FIG. 3A, blade guard 30 also includes a guard shroud 30i that is engaged with the ram 30h. Similar to the series of front shrouds 24, guard shroud 30i covers the front slot 12j to prevent access into the front compartment 12h and the chamber 12g from the front end 12a of deck 12. Such use of the guard shroud 30i shields cut vegetation from being thrown outside of the chamber 12g and front compartment 12h and maintains the cut vegetation inside of the chamber 12g and front compartment 12 h for safety of the operator or individuals that are near or is close proximity to the implement 10 during operation.

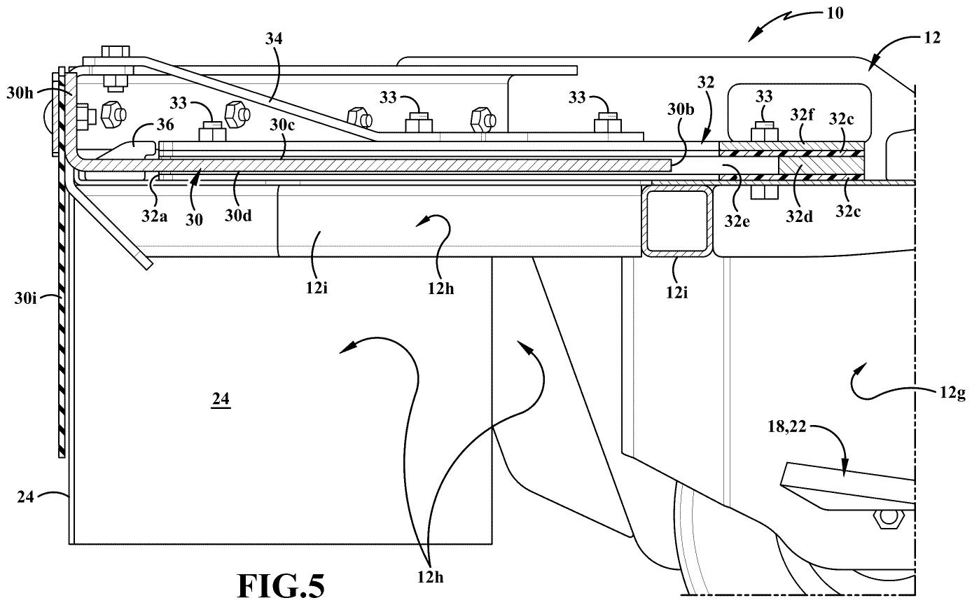

Implement 10 also includes a rail or guide 32 that operably engages with the deck 12 and the blade guard 30. As best seen in FIG. 5, rail 32 operably engages with the top end 12e of deck 12 and is configured to receive a portion of the blade guard 30 for guiding blade guard 30 between the closed position and the open position. Rail 32 includes a first end 32a that is positioned at the front end 12a of deck 12, a second end 32b that is opposite to the first end 32a and positioned away from the front end 12a of deck 12 (see FIG. 3A), and a guide axis or path extending between the first end 32a and the second end 32b. It should be noted that such guide axis is curvilinear in shape due to the rail 32 defining a curvilinear shape when viewed from a top plan view (see FIG. 3A). Such shape of the rail 32 allows the blade guard 30 to pivot about a fixed point and along a curved path with ease from the closed position to the open position.

Still referring to rail 32, rail 32 also includes a pair of slip plates 32c that operably engages with a riser 32d of rail 32. As best seen in FIG. 5, a first slip plate of the pair of slip plates 32c operably engages with a first or top end of the riser 32d in which the first slip plate of the pair of slip plates 32c is positioned above and remote from the top end 12e of the deck 12. Still referring to FIG. 5, a second slip plate of the pair of slip plates 32c operably engages with a bottom end of the riser 32d and with the top end 12e of the deck 12. Still referring to FIG. 5, rail 32 also defines a channel 32e between the first end 32a and the second end 32b along the guide axis. Particularly, the pair of slip plates 32c and the riser 32d collectively define the channel 32e in which a portion of the blade guard 30 is received inside of the channel 32e. Rail 32 also includes a cover plate 32f that operably engages with the first slip plate of the pair of slip plates 32c. The cover plate 32f is positioned outside of the channel 32e and is configured to protect the first slip plate of the pair of slip plates 32c from the exterior environment surrounding implement 10.

Still referring to rail 32, rail 32 also defines apertures 32g in the pair of slip plates 32c, the riser 32d, and the cover plate 32f. Upon assembly of implement 10, connectors 33 operably engage the rail 32 to the top end 12e of deck 12 at the apertures 32g. Any suitable connectors 33 or connection components of the like may be used to secure or attach rail 32 to the deck 12.

Such structural configuration between the blade guard 30 and the rail 32 is considered advantageous at least because the rail 32 guides the blade guard 30 between the closed position and the open position for either protecting blade assembly 18 or exposing blade assembly 18 to cut into freestanding vegetation, such as trees, large shrubs or bushes, and other similar freestanding vegetation. Additionally, the rail 32 allows the blade guide 30 to slide easily inside of the channel 32e when the blade guard 30 is forced from the closed position to the open position by vegetation or forced from the open position to the closed position by a pivot assembly of implement 10, which is discussed in greater detail below. In one example, the rail 32, particularly each slip plate of the pair of slip plates 32c, is formed of a smooth material that defines a low frictional coefficient (such as laminate or similar material) so that the blade guide 30 may slidably transition between the closed position and the open position with ease. As such, the surface of each slip plate of the pair of slip plates 32c that engages with the blade guard 30 may be smooth, continuous, and uninterrupted to allow blade guide 30 to pivot or move with ease.

Implement 10 also includes a rail support or brace 34. As best seen in FIGS. 2 and 3, brace 34 operably engages with the rail 32 along the first plate of the pair of plates 32c and cover plate 32f. In the present disclosure, brace 34 may provide support along an axis that is non-parallel to the guide axis of rail 32 proximate to the first end 32a of rail 32. It should be understood that brace 34 is free from interfering with and/or being in communication with the channel 32e of rail 32 so that brace 34 is free from interfering with blade guard 30.

Implement 10 also includes a pair of stoppers 36, 38 that limits the movement of the blade guard 30 between the closed position and the open position. As best seen in FIG. 5, a first stopper 36 engages with the top end 12e of deck 12 and is positioned at the front end 12a of deck 12. In operation, the first stopper 36 is configured to contact with the forward end 30a of blade guard 30 to prevent the blade guard 30 from over-rotating based on the biasing force applied to the blade guard 30 by a pivot assembly of implement 10, which discussed in greater detail below. As best seen in FIG. 3A, a second stopper 38 engages with the top end 12e of deck 12 and is positioned away from the front end 12a of deck 12. In operation, the second stopper 38 is configured to contact with the trailing end 30b of blade guard 30 to limit the blade guard 30 from over-rotating based on the force applied to the blade guard 30 by vegetation as the implement 10 cuts down the vegetation.

While implement 10 includes a blade guard 30 positioned at the front end 12a of deck 12, blade guard 30 may be operational at other suitable locations or positions along the length of deck 12. In one example, blade guard 30 may be positioned along the first side 12c of deck 12 that is pivotally engaged with the deck 12 between a closed position and an open position based on the type of vegetation being cut by blade assembly 18. In another example, blade guard 30 may be positioned along the second side 12d of deck 12 that is pivotally engaged with the deck 12 between a closed position and an open position based on the type of vegetation being cut by blade assembly 18.

While implement 10 includes a single blade guard 30 that is positioned at the front end 12a of deck 12, implement 10 may include any suitable number of blade guards along deck 12 of implement 10. In one example, implement 10 may include at least two blade guards 30 that are positioned along the same end of deck 12 (e.g., front end 12a) or same side of deck 12 (e.g., first side 12c or second side 12d). In another example, implement 10 may include at least two blade guards 30 that are positioned spaced apart from one another along different ends or sides of deck 12 (e.g., first end 12a, first side 12c, and/or second side 12d). Such inclusion of having more than one blade guard 30 in these exemplary embodiments may assist an operator of vehicle 1 and implement 10 to trim and cut various types of brush, shrubs, trees, and other freestanding vegetation at multiple locations along deck 12 without reorientating and/or realigning implement 10 to each particular freestanding vegetation.

Implement 10 also includes pivot assembly 40 that operably engages with the blade guard 30. As discussed in greater detail below, pivot assembly 40 allows the blade guard 30 to pivot between the closed position (FIGS. 3, 4, 7A, and 7E) and an open position (see FIGS. 7C-7D) so that the blade assembly 18 is exposed and may cut freestanding vegetation. Additionally, the pivot assembly 40 may also be configured to bias the blade guard 30 to the closed position so the implement 10 may cut or trim low vegetation when tall or freestanding vegetation is free from contact and moving the blade guard 30. Such components of the pivot assembly 40 are now discussed in greater detail below.

As best seen in FIG. 3A, pivot assembly 40 includes an actuator or strut 42 that operably engages with the deck 12 and the blade guard 30. In the present disclosure, strut 42 is configured to control the movement of the blade guard 30 as the blade guard 30 transitions between the closed position and the open position by applying axial compression force onto the blade guard 30. In one example, strut 42 is configured to apply axial force against the blade guard 30 to reduce the movement of the blade guard 30 as the blade guard 30 is pushed from the closed position to the open position by vegetation. In another example, strut 42 is also configured to apply force on the blade guard 30 when the force applied by vegetation is removed so that blade guard 30 may return to the closed position. Additionally, strut 42 is also rotatably engaged with the deck 12 and the blade guard 30 by attachment mechanisms 44 (e.g., a bolt that is threadably engaged with a corresponding nut). Such attachment mechanisms 44 are free from hindering the movement and/or rotation of strut 42 when strut 42 is manipulated between an extended position and a compressed position as the blade guard 30 pivots between the closed position and the open position.

It should be noted that any suitable struts, actuators, or similar mechanical components may be used to control the movement of the blade guard 30 as the blade guard 30 transitions between the closed position and the open position. Examples of suitable mechanical components include pneumatic actuators, hydraulic actuators, electrical actuators, electrohydraulic actuators, magnetic actuators, linear actuators, rotary actuators, and other various types of actuator or similar mechanical components.

Still referring to FIG. 3A, pivot assembly 40 also includes a pivot pin 46 that pivotally engages the blade guard 30 to the deck 12. Particularly, the pivot pin 46 engages with the protrusion 30e of blade guard 30 and engages with the top end 12e of deck 12 inside an aperture (not shown) defined in deck 12. It should be noted that pivot pin 46 may also be threaded and be configured to engage with a corresponding nut to maintain the pivot pin 46 with deck 12 and blade guard 30 (see FIG. 2A). Pivot pin 46 also defined a pivot axis 47 that extends along the length of the pivot pin 46 in which the blade guard 30 pivots about during transition between the closed position and the open positioned (see FIGS. 3A and 7B-7C). In the present disclosure, pivot axis 47 is a vertical axis that extends between top and bottom ends 12e, 12f of deck 12 and is generally orthogonal to the longitudinal direction of implement 10 and vehicle 1.

Still referring to FIG. 3A, pivot assembly 40 also includes a biaser 48 that operably engages with the blade guard 30 and the pivot pin 46. In the present disclosure a first end of biaser 48 engages with blade guard 30, particularly hook 30f of blade guard 30, a second end of biaser 48 engages with a biaser retainer 50 of pivot assembly 40 that is fixedly mounted to the top end 12e of deck 12, and a remaining portion of biaser 48 between the first and second ends of biaser 48 is positioned about the pivot pin 46. In operation, biaser 48 is configured to apply a biasing force against blade guard 30 at hook 30f to bias blade guard 30 to the closed position. Such biasing characteristics provided by biaser 48 is used so that the blade guard 30 is maintained at the closed position until vegetation (such as a tree, bush or shrub, or other freestanding vegetation) applies a force against the blade guard 30 that is greater than biasing force applied by the biaser 48. Stated differently, biaser 48 is used so that the blade guard 30 is maintained at the closed position until vegetation (such as a tree, bush or shrub, or other freestanding vegetation) applies a force that overcomes the biasing force applied by the biaser 48 on blade guard 30.

In the present embodiment, biaser 48 is shown as a spring, more particularly as a torsion spring, that applies biasing force on the blade guard 30 to maintain the blade guard 30 in the closed position until vegetation applies a force that overcomes the biasing force applied by the biaser 48 on blade guard 30. It should be appreciated that other suitable biasers or springs of the like may be used in place of biaser 48 disclosed herein along with auxiliary elements or parts that enable such biasers to place a biasing force against blade guard 30 as discussed herein. Examples of suitable biasers include extension springs, compression springs, spiral springs, disk springs, variable-rate springs, linear springs, flat springs, serpentine springs, gas or pneumatic springs, and other springs or biasers of the like that applies biasing force on the blade guard 30 to maintain the blade guard 30 in the closed position until vegetation applies a force that overcomes the biasing force applied by the biaser on blade guard 30.

Having now discussed the components of implement 10 having blade guard 30 and pivot assembly 40, a method of using implement 10 to cut down and remove at least one freestanding vegetation is now discussed in greater detail below.

Prior to cutting down and removing at least one freestanding vegetation with implement 10, the blade guard 30 is in the closed position (FIGS. 3A and 7A). At this state, the blade guard 30 is covering the front compartment 12h defined in deck 12 in which the blade assembly 18, particularly the cutting blades 22, are protected from the exterior environment at the front slot 12j and the top opening 12k. Additionally, with respect to pivot assembly 40, strut 42 is provided in a first or extended state when the blade guard 30 is in the closed position, and biaser 48 is provided in a first or expanded state when the blade guard 30 is in the closed position (see FIGS. 3A and 7A).

As the implement 10 approaches vegetation 60 (in this case, a tree), the blade guard 30 is the initial component of implement 10 that comes into contact with vegetation 60; such moment of implement 10 and vehicle 1 towards vegetation 60 is denoted by an arrow labeled “A” in FIGS. 6-7C. Once vegetation 60 contacts blade guard 30, particularly ram 30h of blade guard 30, the vegetation 60 begins to move the blade guard 30 from the closed position towards the open position as the implement 10 progress into vegetation 60; such movement of the blade guard from the closed position to the open position is denoted by an arrow labeled “B” in FIGS. 7A-7C. As the blade guard 30 transitions to the open position, blade guard 30 is also pivoting about the pivot axis 47 of pivot pin 46 while an end of the blade guard 30 that opposes the pivot pin 46 is being guided by the rail 32 inside of the channel 32e.

Due the structure of vegetation 60 shown herein, vegetation 60 is capable of overcoming the biasing force applied to the blade guard 30 by the pivot assembly 40 since vegetation 60 is free from bending or collapsing based on the biasing force applied to the blade guard 30. As discussed earlier, such structural configuration between the blade guard 30 and the pivot assembly 40 is advantageous so that the blade guard 30 is only opened when large or dense vegetation is needed to be cut down by blade assembly 18 to preserve safety to the operator of implement 10 and to bystanders or other structures proximate to the implement 10 during operation. It should be noted that prior to approaching vegetation 60, blade assembly 18 of implement 10 may be powered to an operating state in which the blade assembly 18 is cutting and/or trimming low level vegetation (such as grass or small shrubs) that fail to apply a force to overcome the biasing force applied to the blade guard 30 by the pivot assembly 40; as such, all cutting and trimming of such low level vegetation occurs inside of the chamber 12g of deck 12 with the blade guard 30 being maintained in the closed position. With respect to vegetation 60 shown in FIGS. 6-7D, however, vegetation 60 is denser and larger that is capable of overcoming the biasing force applied to the blade guard 30 by the pivot assembly 40.

As the implement 10 progresses towards vegetation 60 and the blade guard 30 pivots towards the open position based on the force applied by the vegetation 60, the strut 42 and biaser 48 transition to different states. As best seen in FIGS. 7B-7C, strut 42 transitions from the extended state to a second or compressed state where strut 42 may limit the rotation or speed of the blade guard 30 as the blade guard 30 is guided to the open position by the rail 32; such compression of strut 42 is denoted by an arrow labeled “C” in FIGS. 7B-7C. Still referring to FIGS. 7B-7C, biaser 48 also transitions from the expanded state to a second or compressed state as the force applied by the vegetation 60 (due to implement 10 proceeding into the vegetation 60) is greater than the biasing force applied by biaser 48; such compression of biaser 48 is denoted by an arrow labeled “D” in FIGS. 7B-7C. Blade guard 30 continues to pivot away from the front end 12a of deck 12 and the first stopper 36 until the trailing end 30b of blade guard 30 engages with second stopper 38 or the vegetation 60 reaches the end of the front compartment 12h (see FIGS. 7C and 7D. Once the trailing end 30b engages with the second stopper 38, the blade guard 30 reaches the open position.

At the open position, vegetation 60 is fully seated inside of the front compartment 12h and inside of chamber 12g so that cutting blades 22 may cut down vegetation 60 when rotating; such rotation of cutting blades 22 is denoted by an arrow labeled “E” in FIG. 7D. In this open position, a portion of the blade assembly 18, particularly portions of the cutting blade 22, also extends into front compartment 12h that is viewable through front slot 12j or top opening 12k in order to cut into vegetation 60 for cutting operation; such cutting portion of cutting blade 22 that extends into the front compartment 12h is denoted by a double arrow labeled “CL” in FIG. 7D. In this open position, the strut 42 and biaser 48 of pivot assembly 40 are in the compressed state until the vegetation 60 is cut down from the ground surface. In this open position, a leading end of the blade guard 30 (either the forward end 30a or ram 30h) is parallel to the longitudinal direction of implement 10 in which front compartment 12h is fully exposed to the exterior environment surrounding implement 10.

It should be noted in the present disclosure that cutting blades 22 are not entirely exposed to the vegetation 60 to prevent cutting issues, including the act of bogging down the drive assembly 16, damaging or destroying cutting edges of the cutting blades 22, damaging or destroying the drive assembly 16, and other similar cutting issues. In one exemplary embodiment, at least one-third of a cutting edge of each cutting blade 22 protrudes into the front compartment 12h for cutting freestanding vegetation. In another exemplary embodiment, approximately one-inch of a cutting edge of each cutting blade 22 protrudes into the front compartment 12h for cutting freestanding vegetation.

Once the vegetation 60 is cut down by blade assembly 18 from the ground surface, the blade guard 30 is forced back to the closed position by the pivot assembly 40. Primarily, the biaser 48 forces the blade guard 30 to pivot back to the closed position since the blade guard 30 is no longer being forced opened by a vegetation 60 that is capable of overcoming the biasing force applied by said biaser 48; such expansion of biaser 48 is denoted by an arrow labeled D′ in FIG. 7E. Additionally, strut 42 assists blade guard 30 as blade guard pivots to the closed position (along the rail 32) at a regulated rotational speed to prevent inadvertent damage or stress on the blade guard 30 when an opposing force in no longer applied against the biaser 48; such extension of strut 42 is denoted by an arrow labeled C′ in FIG. 7E. As such, strut 42 regulates the rotation of blade guard 30 between the closed position and the open position. The blade guard 30 continues to pivot towards the open position due to the biasing force applied by the biaser 48 until the forward end 30a of blade guard 30 reengages with the first stopper 36; such pivoting of blade guard 30 back to the closed position is denoted by an arrow labeled B′ in FIG. 7E. Once the blade guard 30 engages with the first stopper 36, the blade guard 30 is now provided in the closed state.

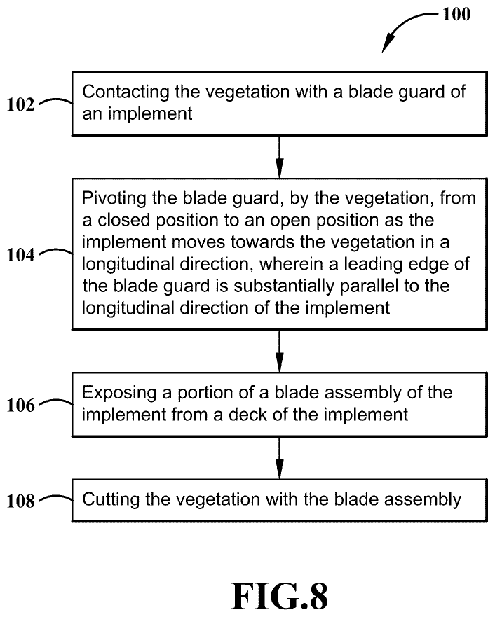

FIG. 8 is a method 100 of cutting vegetation with an implement. An initial step 102 of method 100 includes contacting the vegetation with a blade guard of an implement. Another step 104 of method 100 includes pivoting the blade guard, by the vegetation, from a closed position to an open position as the implement moves towards the vegetation in a longitudinal direction. Another step 106 of method 100 includes exposing a portion of a blade assembly of the implement from a deck of the implement. Another step 108 of method 100 includes cutting the vegetation with the blade assembly.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the implement of the present disclosure is described as a complete unit within the present disclosure, it is to be understood that some of the components or features detailed herein can be supplied as a retrofit kit. This approach enables the provision of only certain parts necessary to upgrade a legacy device to the specifications of implement of the present disclosure. Essentially, instead of requiring the replacement of the entire device, the retrofit kit allows for the selective enhancement of specific components. This could allow a user or operator to efficiently upgrade its/their existing legacy devices, systems, or assemblies to achieve the performance and functionality of the implement of the present disclosure without a full replacement. In the event that a component or portion of the implement of the present disclosure is provided as part of a retrofit kit, those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An implement operable with a tractor, comprising:
a deck having a front end, a rear end opposing the front end, and a longitudinal direction extending between the front end and the rear end;
a blade assembly rotatably coupled to and housed inside of the deck; and
a blade guard pivotally engaged with the deck between a closed position and an open position;
wherein a portion of the blade assembly is exposed from the deck when the blade guard is provided in the open position.

2. The implement of claim 1, wherein when the blade guard is in the open position to expose the portion of the blade assembly, a leading edge of the blade guard is substantially parallel to the longitudinal direction of the deck.

3. The implement of claim 1, further comprising:
a pivot axis extending between top and bottom ends of the deck and being non-parallel to the longitudinal direction of the implement;
wherein the blade guard rotates about the pivot axis between the closed position and the open position.

4. The implement of claim 1, wherein the blade guard moves between the closed position and the open position along a hypothetical plane that is parallel to a top end of the implement.

5. The implement of claim 1, wherein the front end of the deck and a leading edge of the blade guard collectively define a leading end of the implement in the closed position.

6. The implement of claim 1, wherein a predetermined pressure is applied to the blade guard, by vegetation, to pivot the blade guard from the closed position to the open position.

7. The implement of claim 1, further comprising:
a rail operably engaged with the deck and configured to guide the blade guard between the closed position and the open position.

8. The implement of claim 7, wherein a portion of the blade guard is housed inside of and slidably engages with the rail.

9. The implement of claim 1, further comprising:
a pivot pin pivotally engaging the blade guard with a top end of the deck.

10. The implement of claim 9, further comprising:
a biaser operably engaging with the blade guard and the deck and positioned inside of the pivot pin;
wherein the biaser biases the blade guard to the closed position.

11. The implement of claim 1, further comprising:
a strut operably engaging with the blade guard and the deck;
wherein the strut applies linear force against the blade guard as the blade guard pivots from the closed position to the open position.

12. The implement of claim 1, wherein the deck comprises:
a compartment defined by a top end of the deck and a set of supports of the deck extending from the front end of the deck;
wherein a portion of a cutting blade of the blade assembly enters the compartment to cut vegetation inside side the compartment.

13. The implement of claim 12, wherein the blade guard covers the compartment in the closed position at one of the top end of the deck and at the front end of the deck.

14. The implement of claim 12, wherein the blade guard covers the compartment in the closed position at the top end of the deck and at the front end of the deck.

15. A method of cutting an upright vegetation, comprising:
contacting the upright vegetation with a blade guard of an implement;
pivoting the blade guard, by the upright vegetation, from a closed position to an open position as the implement moves towards the upright vegetation in a longitudinal direction;
exposing a portion of a blade assembly of the implement from a deck of the implement; and
cutting the upright vegetation with the blade assembly.

16. The method of claim 15, wherein when the blade guard is in the open position to expose the portion of the blade assembly, a leading edge of the blade guard is substantially parallel to the longitudinal direction of the deck.

17. The method of claim 15, wherein the pivoting the blade guard further comprises:
pivoting the blade guard about a pivot axis extending between top and bottom ends of the deck and being generally orthogonal to the longitudinal direction of implement.

18. The method of claim 15, wherein the pivoting the blade guard further comprises:
moving the blade guard along a hypothetical plane that is parallel to a top end of the implement.

19. The method of claim 15, wherein a front end of the deck and a leading edge of the blade guard collectively define a leading end of the implement in the closed position.

20. The method of claim 15, further comprising:
biasing the blade guard, by a biaser, to the closed position.
